(19) United States
(12) Patent Application Publication
(10) Pub. No.: US 2008/0066435 A1
(43) Pub. Date: Mar. 20, 2008

(54) Air cleaner assembly; components; and, methods

(76) Inventors: Donald Francis Engel, Prior Lake, MN (US); Jordan S. Flagstad, East Bethel, MN (US); Andrew I. Albitz, Mulberry, IN (US); Justin Aaron Kadlec, Coon Rapids, MN (US); Dolan D. Bartels, Delphi, IN (US)

Correspondence Address: MERCHANT & GOULD PC, P.O. BOX 2903, MINNEAPOLIS, MN, 55402-0903, US

(21) Appl. No.: 11/893,229

(22) Filed: Aug. 15, 2007

Related U.S. Application Data
(60) Provisional application No. 60/838,560, filed on Aug. 18, 2006.

(51) Int. Cl. B01D 46/42

(52) U.S. Cl. 55/492; 55/502

(57) ABSTRACT

An air cleaner assembly and components therefor are described. One of the components characterized is a filter cartridge including a first end cap with an outwardly directed pinch seal flange on an end cap at one end of the cartridge; and, an opposite end with a housing seal. An example air cleaner housing is described, for sealingly receiving the filter cartridge therein, during use. Methods of assembly and use are also described.

### FIELD OF THE DISCLOSURE

The present disclosure relates to air cleaner assemblies, to components therefor and to methods of use. The air cleaner assemblies are particularly adapted for utilization mounted on an exterior of a cab of a vehicle, such as a truck. The air cleaner is configured for operation with an in-to-out filtering flow through a serviceable air filter cartridge, during filtering operation.

### BACKGROUND

A wide variety of air cleaner arrangements are known. Many are utilized for filtering engine intake air for vehicles and other equipment such as trucks. Typically the air cleaner includes a housing with a removable access cover; and, a removable and replaceable (i.e., serviceable) filter cartridge positioned within the air cleaner housing. After a period of use, the serviceable filter cartridge is typically sufficiently loaded with dust, so as to require servicing. This is typically done by removing the access cover, removing the filter cartridge from the air cleaner assembly, and providing a “new” filter cartridge in the air cleaner, for further use. The “new” air cleaner cartridge, may comprise: a factory, previously unused filter cartridge; a previously used but refurbished filter cartridge; or, a filter cartridge previously removed but then serviced and then reinstalled. Herein, without specific regard to which of these three possibilities is practiced unless otherwise identified, the cartridge installed during servicing will be referred to as the “new” filter cartridge.

Certain air cleaner arrangements are configured for “in-to-out” flow of air through the serviceable air filter cartridge, during filtering. Some examples are described in U.S. Pat. Nos. 5,613,992; 5,690,712; 5,938,804; 5,897,676; 6,004,366; 6,258,145; 6,322,502; 6,413,289; and, 6,521,009, each of which is incorporated herein by reference.

A typical “in-to-out” flow air filter cartridge of the type characterized in these patents, is characterized by an extension of media surrounding an open central volume and extending between first and second end caps. The first end cap is configured with a central aperture for passage therethrough of inlet air to be filtered. The inlet air is then directed from the inside of the filter cartridge to the outside, with filtering as the air passes through the media. This arrangement traps dust and other material (loaded onto the media) inside of the region surrounded by the filter media. The second end cap can be provided with a drain aperture, to facilitate draining of any water (rain water for example) that may pass into the interior of the filter cartridge, during operation.

Products made in accord with arrangements and principles described in the above-referenced U.S. Pat. Nos. 5,613,992; 5,690,712; 5,938,804; 5,897,676; 6,004,366; 6,258,145; 6,322,502; 6,413,289; and, 6,521,009, have involved a cylindrical media pack inside of a cylindrical housing. Such an arrangement provides a relatively large profile in projection outwardly from the side of the vehicle, such as a truck. It is desirable to obtain an alternate configuration. In addition, improvements in filter cartridge construction and installation are sought.

### SUMMARY OF THE DISCLOSURE

According to the present disclosure air cleaner assemblies and components therefor are provided. The air cleaner assemblies typically include a removable and replaceable (i.e., serviceable) air filter cartridge. The air filter cartridge generally comprises a media pack extending between first and second end caps. The first end cap includes a central air flow aperture and an outwardly directed pinch seal flange arrangement thereon, the pinch seal arrangement extending radially outwardly away from the media pack in a direction also away from the second end cap. The second end cap typically includes a housing seal portion thereon and a drain arrangement. The housing seal portion of the second end cap is typically an outwardly directed radial seal portion.

Specific examples are depicted, in which the outwardly directed pinch seal flange and the media pack each have an oval perimeter shape.

Specific advantageous features are shown and described.

Also described are air cleaner arrangements, including a filter cartridge as described. The air cleaner arrangement typically includes a housing having an air flow inlet, an air flow outlet and a filter cartridge receiving base with a liquid drain arrangement therein. A seal support is positioned on the filter cartridge receiving base; the seal support including an open central aperture through which the cartridge can project when installed. A seal plate assembly is removably mounted on the seal support, to pinch the pinch seal flange on the cartridge to form a seal between the seal plate assembly and the seal support.

Methods of assembly and use are also described.

There is no specific requirement that a construction include all of the features characterized herein, in order to obtain some advantage according to the present disclosure.

### BRIEF DESCRIPTION OF THE DRAWINGS

FIG. 1 is a schematic side elevational view of an air cleaner assembly according to the present disclosure.

FIG. 1A is a schematic, top plan view of the air cleaner assembly depicted in FIG. 1.

FIG. 2 is an enlarged schematic top plan view of the air cleaner assembly depicted in FIG. 1, with an inlet/access cover assembly and seal plate assembly removed.

FIG. 3 is a schematic cross-sectional view taken along line 3-3, FIG. 2; but showing the air cleaner assembly with the inlet/access cover assembly and seal plate assembly in place.

FIG. 4 is a schematic cross-sectional view taken along line 4-4, FIG. 2; but showing the assembly with the inlet/access cover assembly and seal plate assembly in place.

FIG. 5 is an enlarged, schematic, perspective view of a filter cartridge for installation of air cleaner of FIGS. 1-4.

FIG. 6 is a schematic cross-sectional view of the filter cartridge of FIG. 5, taken along line 6-6, FIG. 5.

FIG. 7 is a schematic cross-sectional view of the filter cartridge of FIG. 5, taken along line 7-7, thereof.

FIG. 8 is a schematic view analogous to FIG. 3 but depicting the air cleaner assembly with an inlet/access cover assembly and seal plate assembly removed.

FIG. 9 is an enlarged, schematic, fragmentary view of a first portion of FIG. 8.

FIG. 10 is an enlarged, schematic, fragmentary view of a second portion of FIG. 8.

FIG. 11 is a schematic, exploded, perspective view of selected external portions of the air cleaner assembly of FIG. 1.

FIG. 12 is a schematic exploded perspective view of selected interiorly received portions of the air cleaner assembly of FIG. 1.

FIG. 13 is a schematic exploded top perspective view of selected portions of the air cleaner assembly of FIG. 1, depicting an interaction with an upper end cap of the filter cartridge of FIG. 5.

FIG. 14 is a schematic exploded view of selected componentry depicted in FIG. 13.

FIG. 15 is a schematic enlarged fragmentary view of a portion of FIG. 3.

FIG. 16 is a schematic enlarged fragmentary view of a portion of FIG. 6.

FIG. 17 is a schematic enlarged schematic fragmentary view of a second portion of FIG. 6.

FIG. 18 is a schematic bottom perspective view of the filter cartridge of FIG. 5.

FIG. 19 is a schematic top perspective view of a seal plate assembly component of the assembly of FIG. 1.

FIG. 20 is a schematic side elevational view of the component depicted in FIG. 19.

FIG. 21 is a schematic bottom plan view of the component depicted in FIG. 19.

FIG. 22 is a schematic top plan view of a bottom end cap insert component of the filter cartridge depicted in FIG. 5.

FIG. 23 is a schematic bottom perspective view of the component depicted in FIG. 22.

FIG. 24 is a schematic side elevational view of the component depicted in FIGS. 22 and 23.

### DETAILED DESCRIPTION

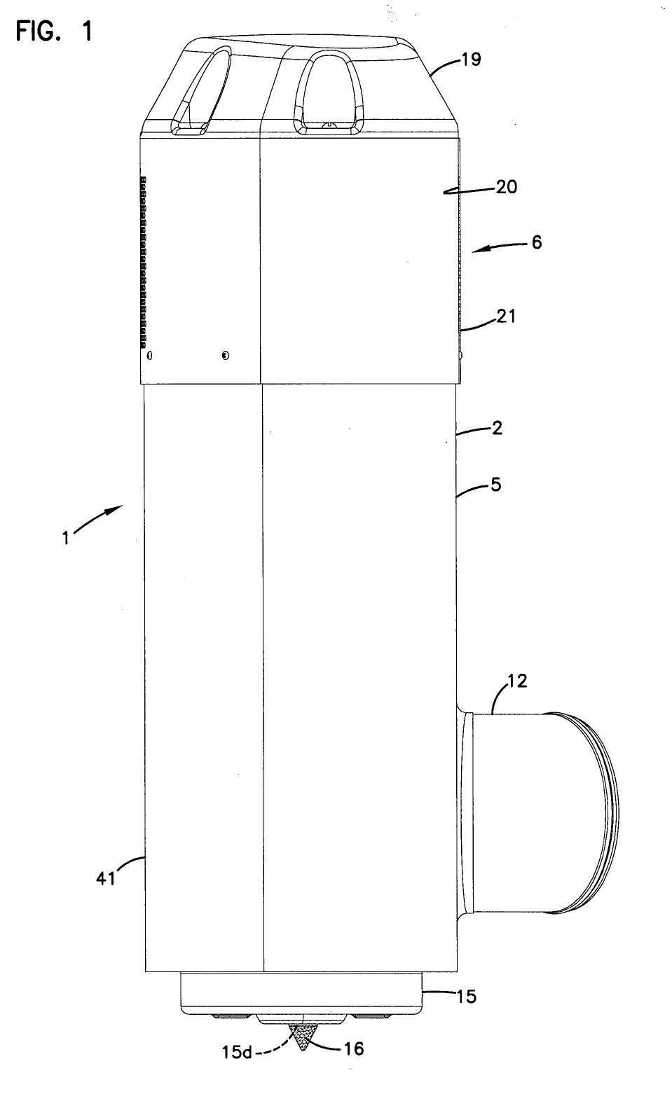

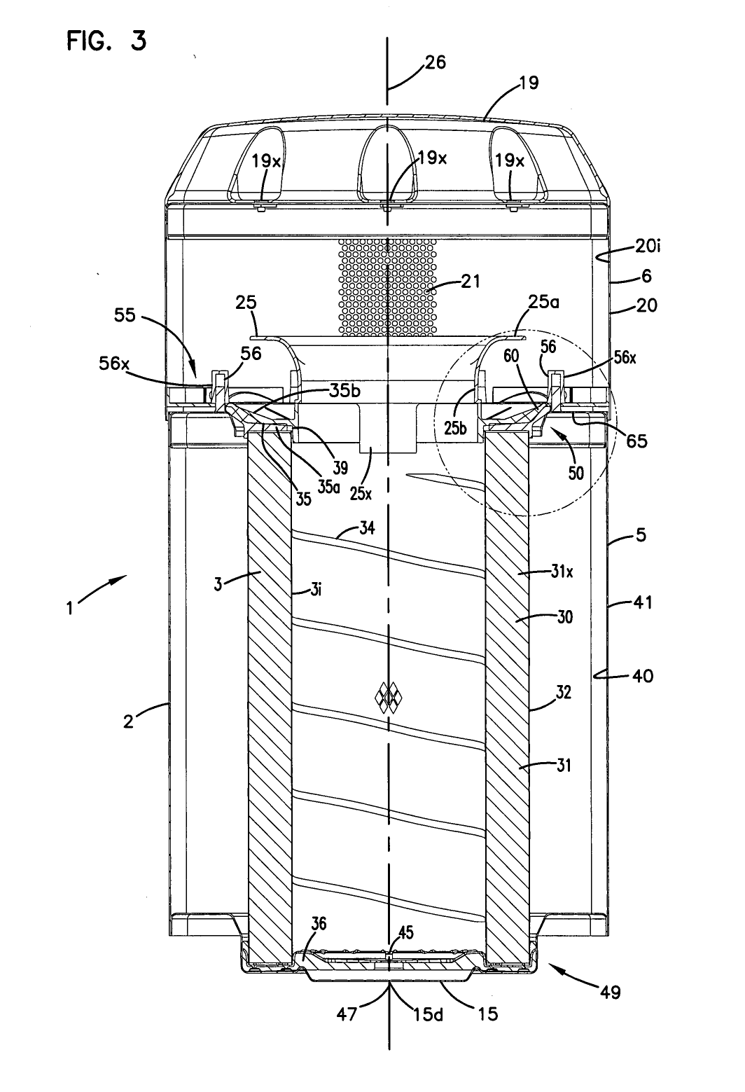

The reference numeral 1, FIG. 1, generally indicates an air cleaner assembly according to the present disclosure. The air cleaner assembly 1 includes a housing 2 and an internally received, removable and replaceable, i.e., serviceable, filter cartridge 3, not viewable in FIG. 1, see for example FIG. 3.

The housing 2, FIG. 1, generally includes a body or base 5 and a removable inlet/access cover assembly 6. When the inlet/access cover assembly (or cover) 6 is removed from a remainder of the air cleaner housing 2, i.e., from base 5, service access to interior structure, for servicing of the filter cartridge 3, is provided. The inlet/access cover assembly 6 is configured to allow for receipt of inlet flow of air to be filtered into the inlet/access cover 6. Internal structure within inlet/access cover assembly 6 will direct the incoming air into body or base 5, for filtering. This is discussed further below, in connection with other figures.

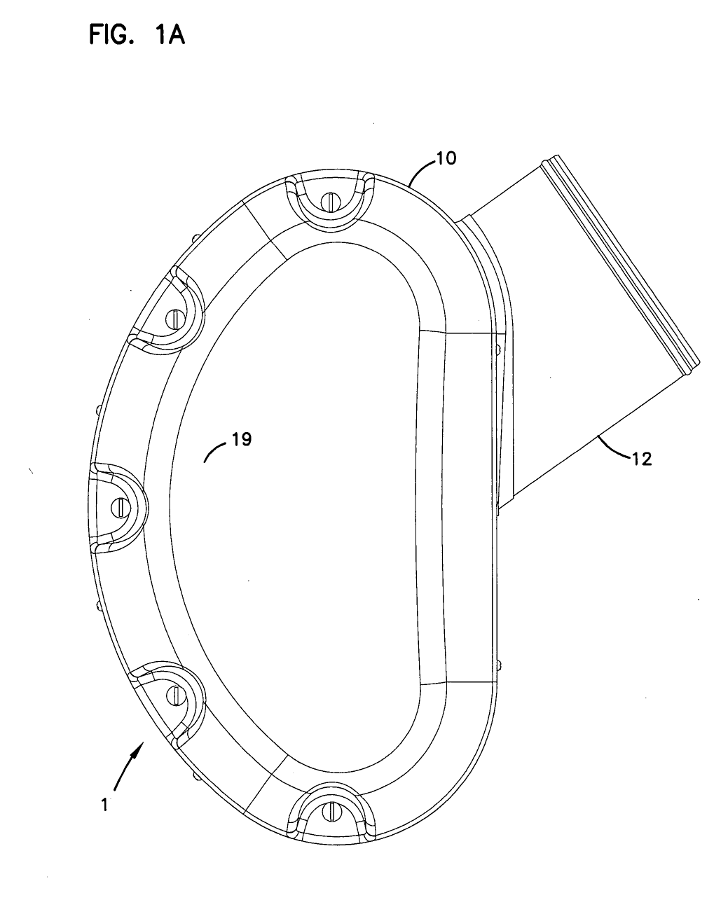

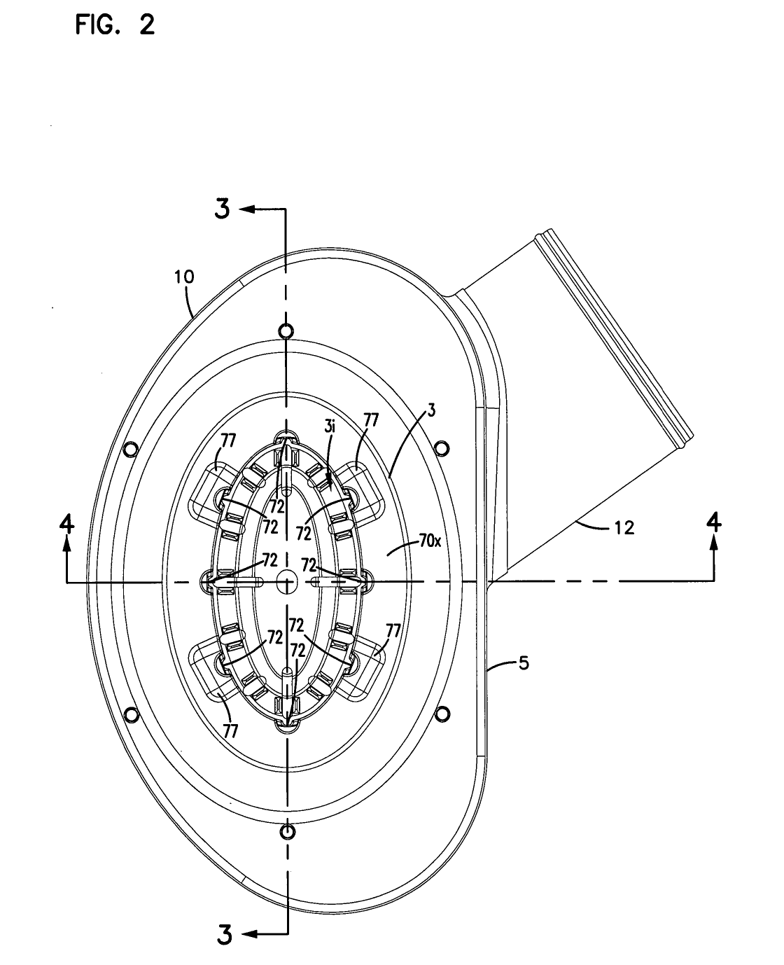

The housing base 5, for the example shown, generally has a non-circular shaped perimeter shape or cross-sectional definition. This will be understood, for example, by reference to FIG. 1A, a top plan view; and, FIG. 2, which shows base 5 with inlet/access cover assembly 6 removed and also with a seal plate assembly discussed below removed. The non-circular housing perimeter for the housing base 5 is generally shown at 10. The housing 2 includes, in base 5, an air flow outlet tube 12, FIG. 1. The outlet tube 12 allows for passage of filtered air from the air cleaner assembly 1 to downstream equipment, such as an engine combustion air intake, for the vehicle or other equipment involved.

Referring again to FIG. 1, the air cleaner assembly 1 would typically be installed in the orientation shown, i.e., a vertical orientation, with inlet/access cover assembly 6 at an upper end and base 5 at a lower end. Base 5 includes a lower end piece 15. The lower end piece 15 would typically include a drain aperture 15d therein, shown in FIG. 1 as covered by evacuator valve 16. The lower central drain aperture and evacuator valve 16, allow for selective drainage of water that, for example, may collect in an interior of air cleaner assembly 1 during use.

Attention is now directed to FIG. 3, a cross-sectional view taken along line 3-3, FIG. 2, but with inlet/access cover assembly 6 and a seal plate assembly discussed below in place. From reference to FIG. 3, general operation of air cleaner assembly 1 can be understood. Inlet/access cover assembly 6 includes a top 19 and side screen arrangement 20. The top 19 is removably secured to the side screen arrangement 20, for example, by bolts or other attachment (fastener) arrangement 19x. The side screen arrangement 20 includes perforate perimeter screen portion or region 21. Air to be filtered can pass into an interior 20i surrounded by screen 20, by passage through perforated (perforate) screen region 21. Perforated (perforate) screen region 21 would typically extend all the way around an outer circumference of screen 20. Perforated portion 21, i.e., side screen 20, thus allows for inlet flow of air to be filtered into housing 2.

Unfiltered air entering side screen arrangement 20 is directed into base 5, through inlet stack or inlet tube 25. More specifically, inlet stack 25 directs air flow into interior 3i of filter cartridge 3.

For the example shown in FIG. 3, inlet stack of inlet tube 25 comprises an upper outer flared end 25a and a lower axial tube section 25b, for facilitating collection of inlet air and directing it into cartridge interior 3i. Herein the term “axial” is used to refer to features generally in line with a central axis of housing 2 and cartridge 3; the axis generally being oriented to extend vertically when assembly 1 is in an installed position. A line generally corresponding to a central axis line, is indicated at 26. Hence the previously used term “axial tube section 25b,” refers to a tubular section 25b that extends generally around, and parallel to, tube axis 26.

Filter cartridge 3 generally comprises a media pack 30 including filter media 31 surrounding open interior 3i. The media pack 30 can further include an outer liner 32 and/or an inner liner 33, supporting the media 31 on one or both of opposite sides.

Typically, pleated filter media 31x will be used for the media 31 with inner and outer pleat tips extending between end caps 35, 36, although alternatives are possible. Typically an expanded metal or perforated metal screen would be used for each of the inner and outer liners 33, 32 respectively, although alternatives are possible. When pleated media 31x is used, a bead arrangement 34 can be used to facilitate pleat spacing, on both inner pleat tips (FIG. 3) and outer pleat tips (FIG. 5). Such bead arrangements are well known and widely used for conventional pleated media. In addition, the media can be provided with embossing or other folds therein, to facilitate pleat spacing; and, the media can be provided with corrugations extending generally perpendicular to the pleat direction, again to facilitate pleat spacing. These techniques are also well known and widely utilized in pleated media arrangements. Further, in some instances the media 31x can be treated with a fine fiber treatment on one or both sides thereof.

The media pack 30, including the media 31, extends between opposite end caps 35, 36. End cap 35 has a large open central aperture 39, through which a portion 25x of inlet stack 25 projects and around which media pack 30 extends. This allows unfiltered air to pass into interior 3i of filter cartridge 3. Filtering flow of air then occurs as the unfiltered air moves from central region 3i through the media pack 30, into annular region or annulus 40. Annulus 40 is a clean air annulus surrounding the media pack 30 and cartridge 3, between the media 31 and housing base side wall 41. The filtered air from annulus 40 can then pass outwardly from air cleaner 1, through outlet tube 12, FIGS. 1 and 2.

Dust and other material removed from the unfiltered air, generally remains in interior 3i of filter cartridge 3, FIG. 3.

End cap 36, FIG. 3, includes a drain aperture arrangement 45 therein. Drain aperture arrangement 45 provides a flow passageway from interior 3i into bottom 15 of housing 2. This allows, for example, for drain of material such as water (for example rain water from cartridge interior 3i, through drain arrangement 15d; i.e., through drain 47.

Since end cap 36 includes drain aperture arrangement 45 therein, end cap 36 is not completely closed. Air cleaner assembly 1, then, requires a seal arrangement (a) inhibiting unfiltered air in region 3i, from bypassing the media pack 31 by passage through aperture 45, from reaching clean air annulus 40; and (b) inhibiting any unfiltered air passing into bottom 15 of housing 2 through drain aperture 47, from entering annulus 40. This is provided by a housing seal arrangement 49. The particular example housing seal arrangement 49 depicted involves end cap 36 and is discussed in more detail further below. A variety of alternate seal arrangements, for housing seal arrangement 49, however, can be used.

Another seal arrangement is important to operation of air cleaner assembly 1. This seal arrangement is indicated generally at 50, and is positioned to prevent unfiltered air in screen interior 20i, or exterior of housing 2, from entering annulus 40.

Referring to FIG. 3, air cleaner assembly 1 includes seal plate assembly 55.

The seal plate assembly 55 is removably secured in place, by a fastener system 56. When the fastener system 56 is released, the seal plate assembly 55 can be lifted off a mounting, on which it is positioned. Although alternatives are possible, the fastener system 56, typically comprises a bolt/nut arrangement 56x that drives the seal plate assembly 55 downwardly, toward housing bottom 15. The seal plate assembly 55 are discussed in more detail in connection with other figures below.

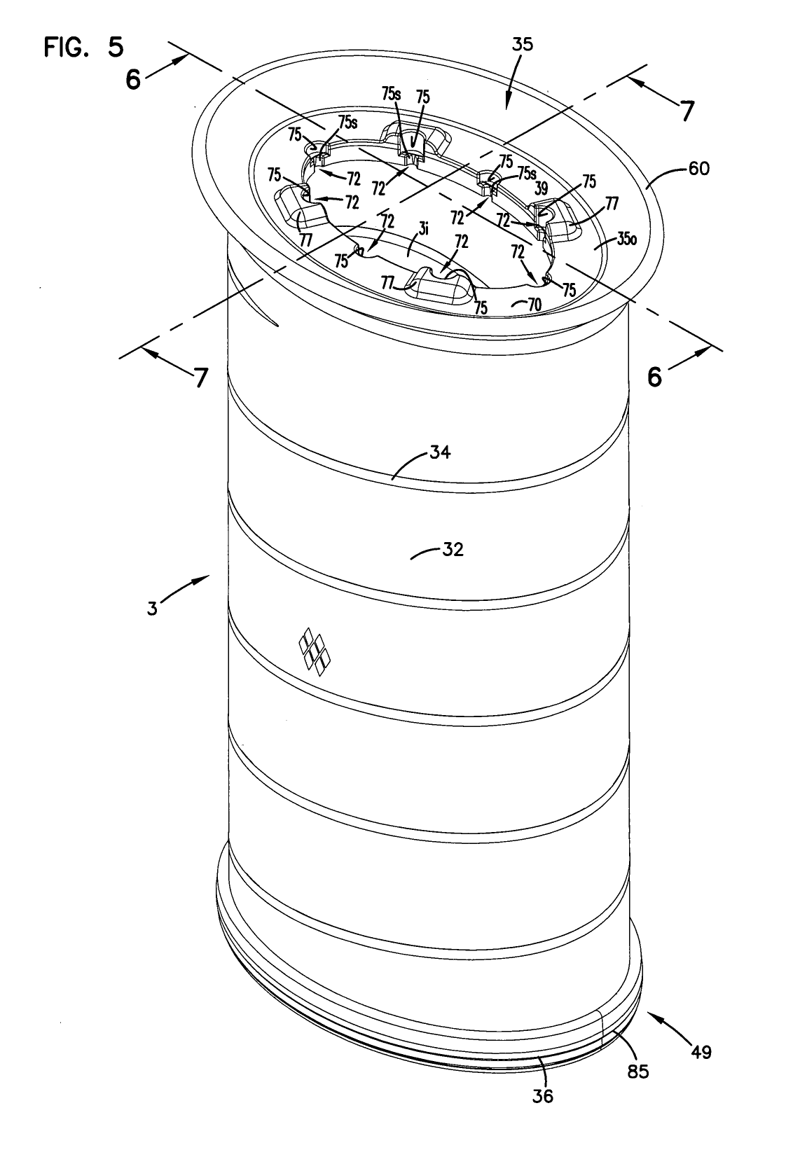

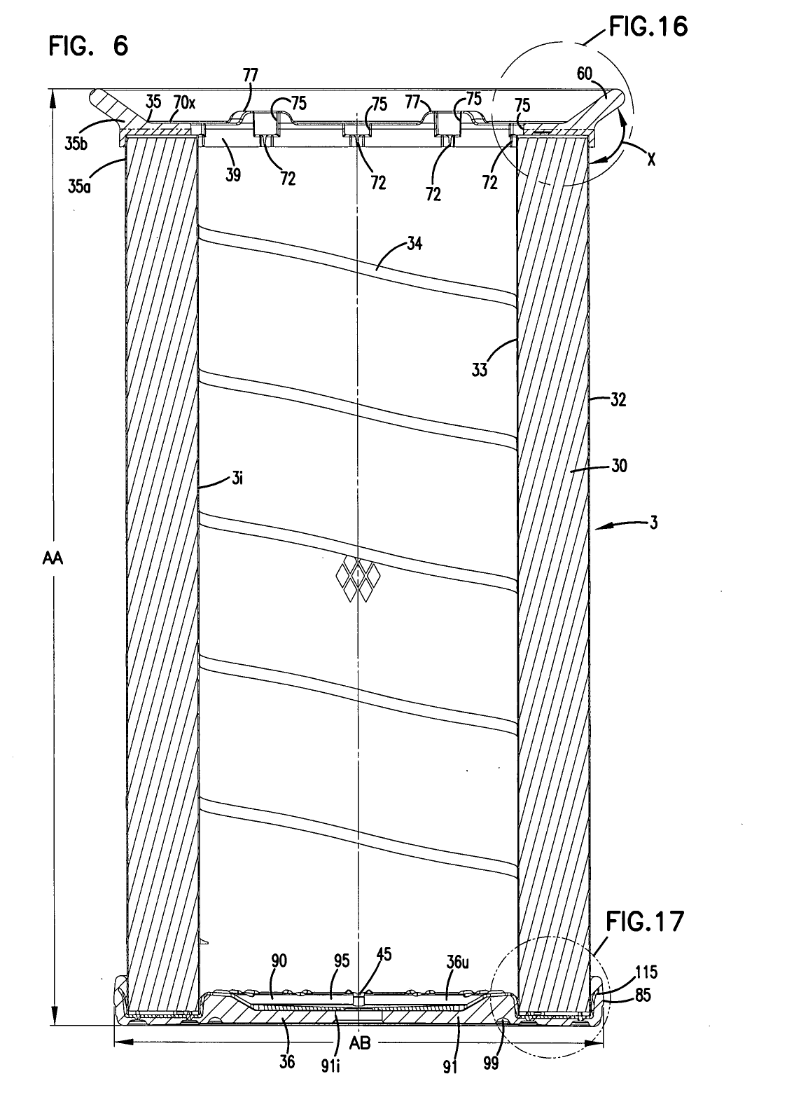

Referring still to FIG. 3, cartridge end cap 35 is provided with outwardly directed pinch seal flange 60 thereon. The outwardly directed pinch seal flange 60 is a portion of seal arrangement 50, previously identified. The seal flange 60 comprises a flexible extension, directed away from a remainder of end cap 35 in a direction radially outwardly from media pack 30 and typically is directed axially away from opposite end cap 36 and the media pack 30. That is, typically and preferably, flange 60 extends outwardly generally at an angle x, FIG. 6, with respect to media pack 30 which is greater than 90°, i.e., flange 60 extends both radially outwardly from media pack 30 and also axially away from opposite end cap 36. The term “pinch seal flange” as used herein is meant to refer to a seal flange clamped between two housing members to form a seal, in use.

For the arrangement shown, the flange 60 is inseparable from a remainder of end cap 35. For a typical example, the end cap 35, with flange 60, is molded-in-place, although alternatives are possible.

For the particular example shown, FIG. 6, end cap 35 comprises two molded sections: an axially inner section 35a; and, an axially outer section 35b. In a typical application, axially inner section 35a would be a relatively stiff, hard material; and, axially outer section 35b would be a relatively soft, compressible, material. By “axially inner” in connection with section 35a, it is meant that section 35a is underneath section 35b and against an axial end of the media pack 30. By “axial outer” in connection with section 35b, it is meant that section 35b is on an opposite side of section 35a, from the media pack 30.

Typically outer section 35b would include flange 60 molded integral therewith, for example from a soft compressible polyurethane as discussed below. Typically section 35a would be relatively hard, stiff material, again, for instance, a polyurethane. In a typical operation for formation of end cap 35, an appropriate formulation to form region 35a would be put into the bottom of the mold. An appropriate formulation to form region 35a would then be put on top of the material forming region 35b, and the media pack 30 would be appropriately positioned. Region 35a, being a relatively hard, stiff, material, will help retain the media pack 30 in a desired configuration. Region 35b, comprising a softer more compressible material, is good for utilization to form the pinch seal flange 60. When both sections are formed by polyurethane, but formulated differently, a good adherence (cohesive bond) between the two sections 35a, 35b results. It is noted, however, that the techniques described can be applied with alternate end cap materials, and alternate end cap configurations.

Referring to FIG. 3, in assembly 1, the flange 60 is compressed (pinched) between a portion of seal plate assembly 55 and a portion of a housing seal support 65 under axial pressure applied by fastener arrangement 56.

With respect to this, attention is directed to FIG. 15, an enlarged fragmentary view of a portion of FIG. 3. Referring to FIG. 15, housing seal support 65 comprises upper central portion 65a, radially inward, depending, portion 65b and radially outward, depending, portion 65c. Radially outward depending portion 65c is configured for engagement with, and securement to, outer wall 41 of base 5. Inner depending wall 65b defines an inner aperture 65d through which cartridge 3 projects. In particular aperture 65d surrounds end cap 35, with media pack 30 depending from end cap 35. Between inner depending section 65b and central section 65a shoulder 65x is provided, against which seal flange 60 is compressed, by seal plate assembly 55, during installation.

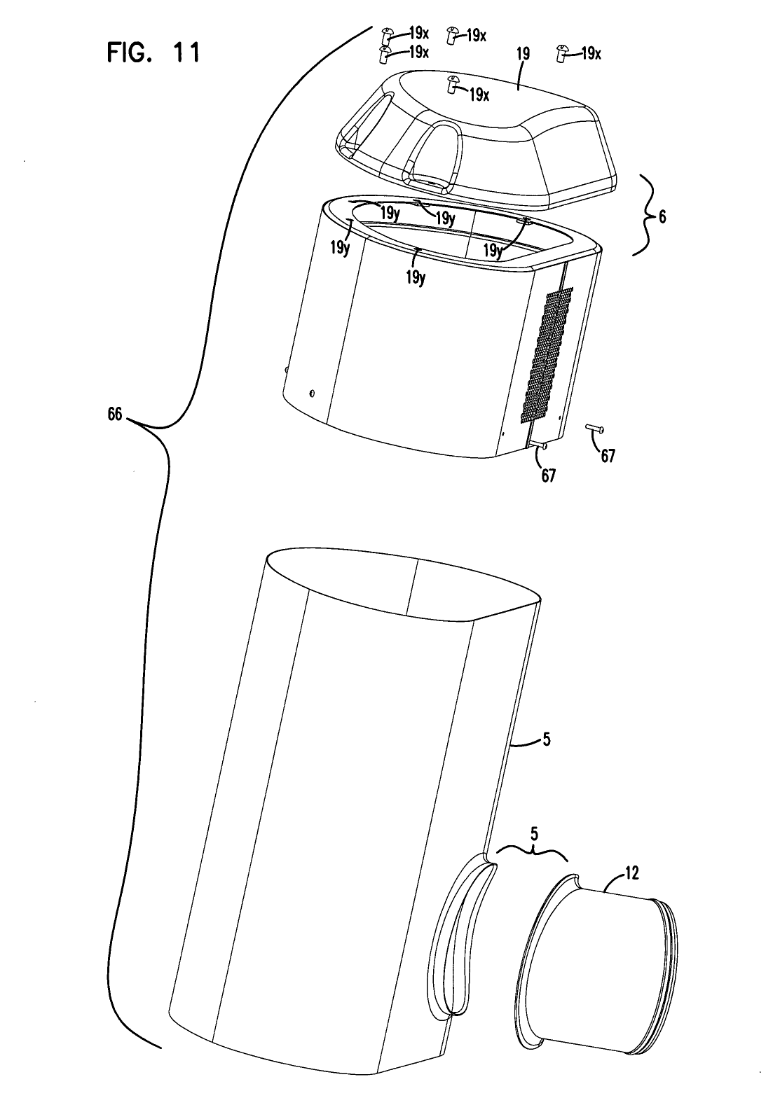

Further regarding these seal features characterized can be understood by reference to FIGS. 11-13. Referring first to FIG. 11, an exploded perspective view is shown depicting selected exterior portions 66 of the air cleaner assembly 1. In particular exterior portions of inlet/access cover assembly 6 and housing base 5 are shown. Referring to FIG. 11, inlet/access cover assembly 6 can be seen to comprise top 19 and screen arrangement 20. The top 19 is securable to the screen arrangement 20 by a plurality of fasteners 19x, in this instance comprising bolts or screws driven into weld nuts 19y; the weld nuts 19y being on an inwardly directed flange 20x of screen section 20.

Also viewable in FIG. 11 are base portion 5 and outlet 12. In FIG. 11, no effort is made to show detail of structure relating to the mounting of side screen section 20, to base 5. This will be understood by reference to other figures, discussed hereafter.

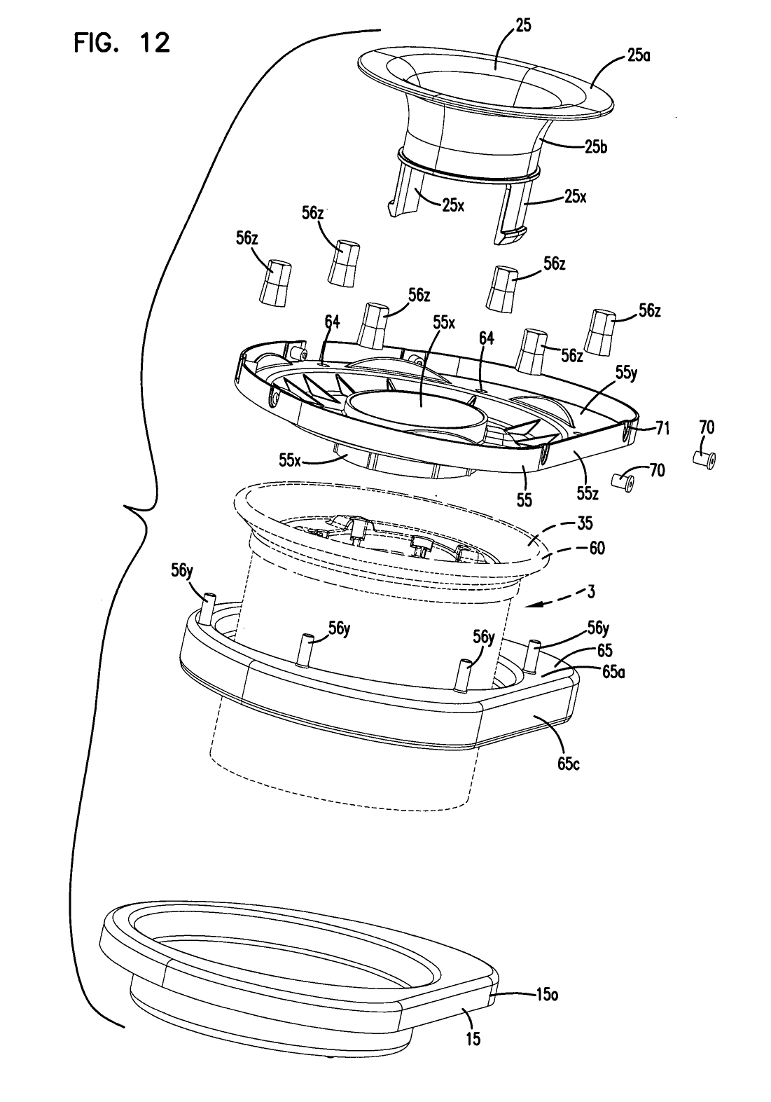

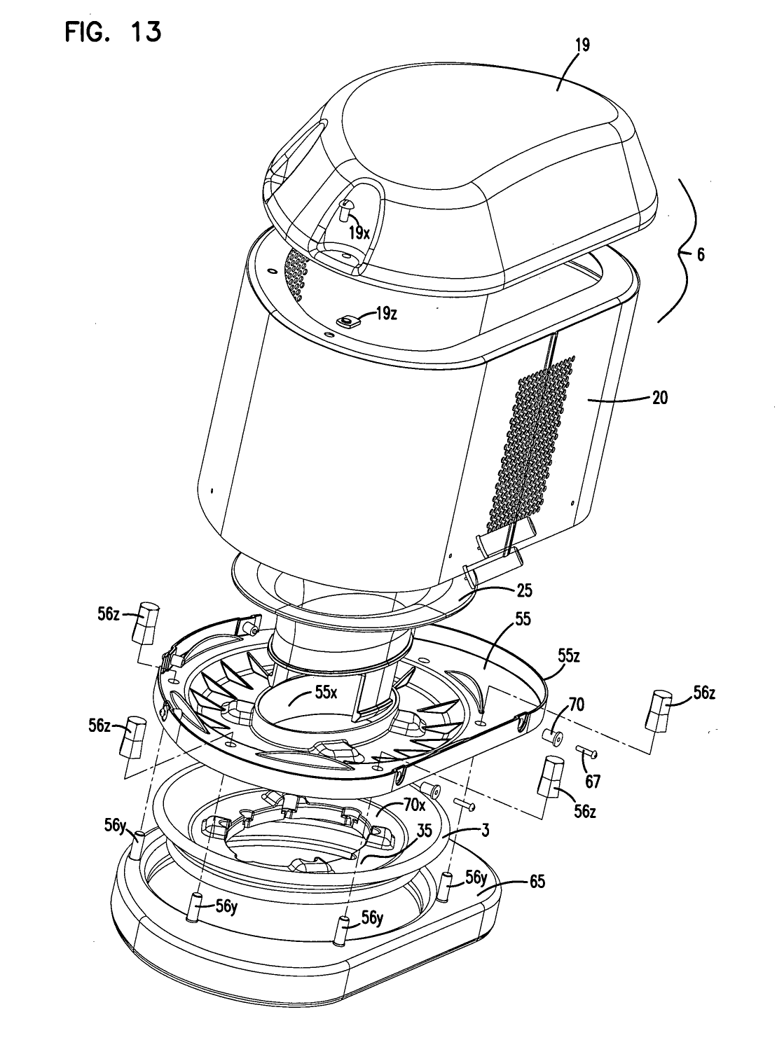

Still referring to FIG. 11, fasteners 67 relate to an attachment arrangement, for securing the seal plate assembly 55 to side screen section 20. More regarding this will be understood from FIGS. 12 and 13.

Referring to FIG. 12, certain interior structural componentry is depicted. Referring to FIG. 12, inlet stack 25 is viewable, having depending snap fit projections 25x, for snap fit within hub 55x of the seal plate assembly 55. The seal plate assembly 55 can be seen as including central tubular hub or section 55x, flange portion 55y, and outer mounting lip 55z. Also shown is seal support 65. The seal support can be seen to include outer depending lip 65c, by which it can be retained with an interior 5i of housing base 5, FIG. 11. Central section 65a is seen with threaded studs 56y thereon. The seal plate assembly 55 would be secured to the seal support 65, with nuts 56z engaging the studs 56y and with the studs 56y projecting through apertures 69 in the flange portion 55y of the seal plate assembly 55.

Still referring to FIG. 12, fastener members 70 are shown positioned to extend through apertures 71, in outer mounting lip 57 of seal plate assembly 55. The fasteners 70 help provide for securement to a portion of side screen arrangement 20. This will be understood further, from reference to FIG. 13, below.

Still referring to FIG. 12, cartridge 3 is depicted in phantom, with end cap 35 in particular flange 60 positioned between seal plate assembly 55 and seal support member 60. Also depicted in FIG. 12, is bottom 15 of housing 5. Bottom 15 would generally be secured by outer flange 15o in a lower portion of housing side wall 41, FIG. 1.

Attention is now directed to FIG. 13, an exploded perspective view of selected portions of the air cleaner assembly 1 discussed and identified in connection with FIGS. 11 and 12. In FIG. 13, only the end cap 35 portion of cartridge 3 is depicted, for convenience. Bolts 67 are shown engaged with fasteners 70 and flange 55z, to secure screen member 20 to seal plate assembly 55. From this description, it can be understood that once top 19 is removed from screen 20, a service provider could reach into an interior 20i of screen arrangement 21, to obtain access to nuts 56z. Once the nuts 56z are loosened, by lifting screen member 20 (which is secured to seal plate assembly 55), the seal plate assembly 55 is lifted away from the cartridge 3. The cartridge 3 could then be lifted out of the assembly and be replaced by a new cartridge. (Alternatively, screws 67 could be loosened, to gain access to nuts 56z).

Installation of the new cartridge 3 would be a reverse operation.

Since inlet stack 25 is snap fit to hub 55x of seal plate assembly 55, with projection therethrough, stack 25 will lift out of the place, along with seal plate assembly 55, when the screen arrangement 20 is lifted off bolt post 56y.

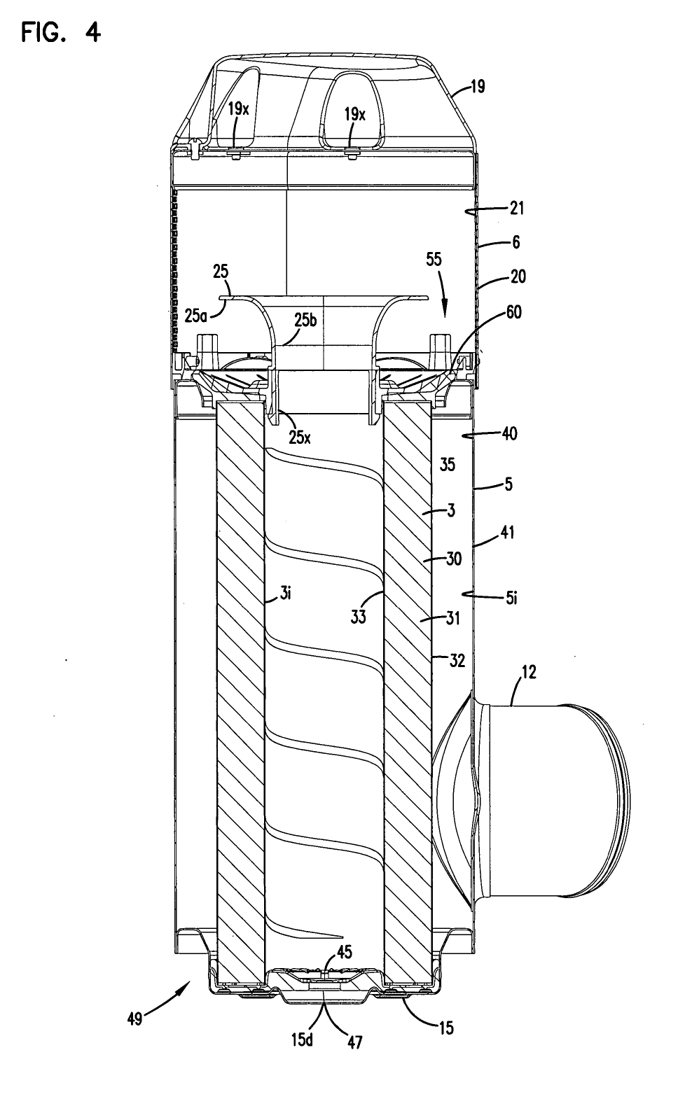

Attention is now directed to FIG. 4, a cross-section taken along line 4-4, FIG. 2, but with seal plate assembly 55 and inlet/cover access assembly 6 in place. From a comparison of FIGS. 2, 3 and 4, the non-circular cross-section to the housing base 5 can be understood.

Efficient utilization of the interior space 5i of base 5 can be accomplished, by avoidance of a filter cartridge having a generally circular cross-section. Although a variety of shapes are possible, for the example depicted a filter cartridge 3 having an oval cross-sectional (or perimeter) shape, (for example elliptical) is selected.

Attention is now directed to FIG. 5, in which cartridge 3 is depicted in perspective view, media pack 30 being shown schematically extending between end caps 35 and 36. Referring to FIG. 5, end cap 35 includes sealing lip 60 and axial end (ring) portion 70x, end portion 70x generally extends axially over an end of media pack 30, defining open central (oval shaped) aperture 39 surrounded by media pack 30. Central aperture 39 includes an inner surface 39i including at least one, and typically a plurality of, spaced insets or channels 72 therein. Each one of insets or channels 72 extends vertically through a portion of end cap 35 and is open to (i.e., is in communication with) aperture 39. For the example shown, the number of insets 72 is eight (8), however alternate numbers can be used. Typically there will be at least four (4) insets 72 and usually not more than twelve (12) insets 72. For the example shown, the insets 72 are generally semicircular in cross-section, although alternatives are possible. The insets 72 are typically end cap artifacts from centering pins in a mold operation, used to center the media pack 30 in an appropriate location. The insets 72 can also be used for engagement with selected housing features, as discussed below.

Still referring to FIG. 5, end cap 35 also includes, positioned around aperture 39, standoff recesses 75. The standoff recesses 75 are mold artifacts, from where mold standoffs would be positioned, to support the media pack 30, during molding of end cap 35. Each standoff recess 75 includes a standoff shoulder 75s. Extending downwardly from each standoff shoulder 75s, is provided an inset 72. In combination with the associated standoff recess 75s, each inset 72 extends completely through end cap 35, in a vertical dimension.

Positioned on surface 35 of ring portion 70 of end cap 35, are positioned spaced axial projections 77. For the example shown, the spaced axial projections 77 are positioned one associated with alternating ones of the insets 72, with each associated inset 72 (in combination with a standoff, recess 75) extending through the entire end cap 35, including the projection 77. Each projection 77 is somewhat rectangular in shape, with three (3) slanted sides; and, each projection 77 is adjacent the aperture 39. Each axial projection 77 axially overlaps the media pack 30.

The insets 72, projections 77 and mold standoffs 75 are typically molded integral with the remainder of end cap 35. For the example shown there are four spaced projections 77, although an alternate number can be used. Typically there will be at least three and usually not more than eight (8). Typically each projection 77 will be associated with an inset 72, although alternatives are possible.

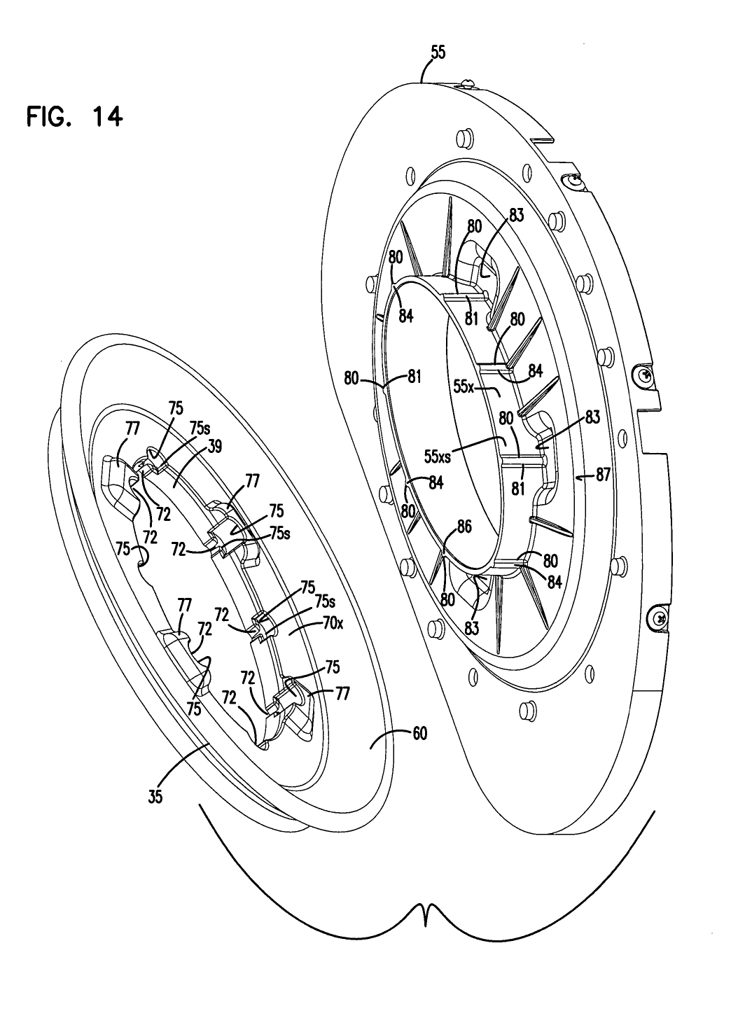

Attention is now directed to FIG. 14. In FIG. 14, a combination comprising end cap 35 and seal plate assembly 55 is shown. As discussed with respect to FIG. 12, seal plate assembly includes depending hub or tube 55x. Tube 55x includes an outwardly directed surface 55xs at least one rib 80, and typically a plurality of spaced ribs 80 on an outer surface thereof.

For the example shown, each of the ribs 80 generally extends vertically, in the air cleaner as assembled in its operational use, FIG. 1; i.e., the ribs 80 extend generally parallel to the direction of extension of hub 55x and axis 26, FIG. 3. The ribs 80 generally project radially outwardly, from a remainder of hub 55x.

Selected ones, 81, of the ribs 80 are positioned to mate with; i.e., extend through, those of insets 72 with projections 77, when the seal plate assembly 55 and end cap 35 engage during assembly, FIG. 3. Each of these ribs 81 is associated with an upwardly directed rectangular receiver 83, sized and configured for mating arrangement with, or receipt of, one of the projections 77, FIG. 5, during installation. Between ribs 81, are positioned ribs 84. The ribs 84 are selected ones of ribs 80 sized and positioned to similarly engage those of insets 72 that do not extend through projections 77.

Still referring to FIG. 14, it is noted that seal plate assembly 55 includes depending (somewhat frusto-conical) flange 87 thereon, for engaging and compressing lip 60 during sealing.

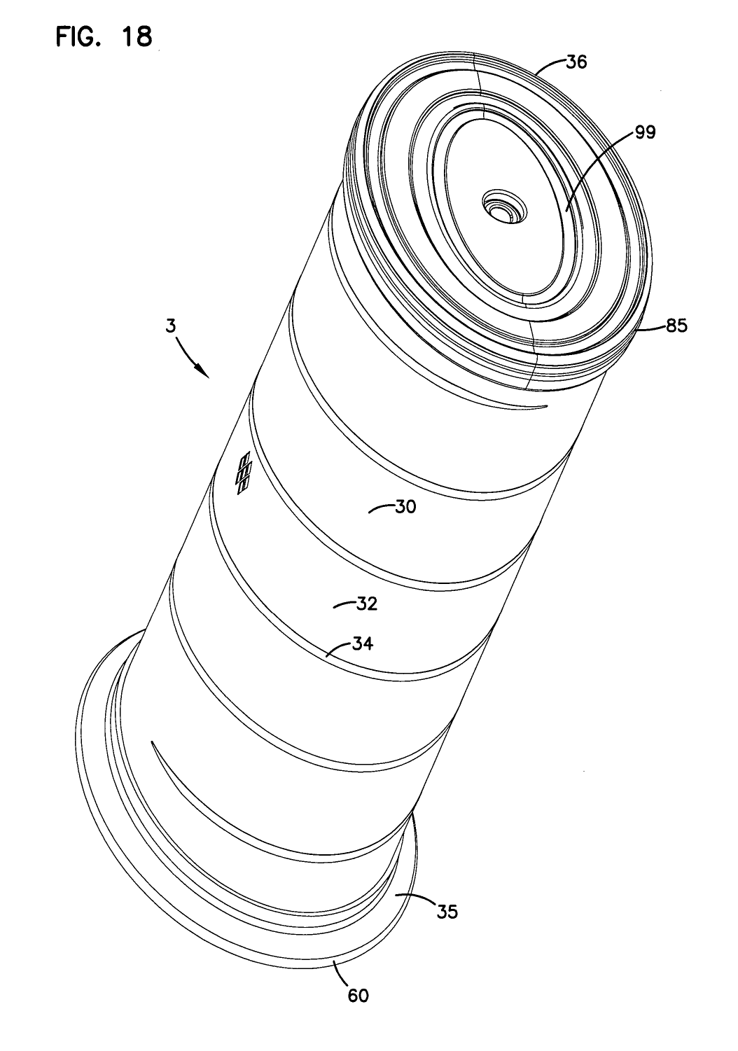

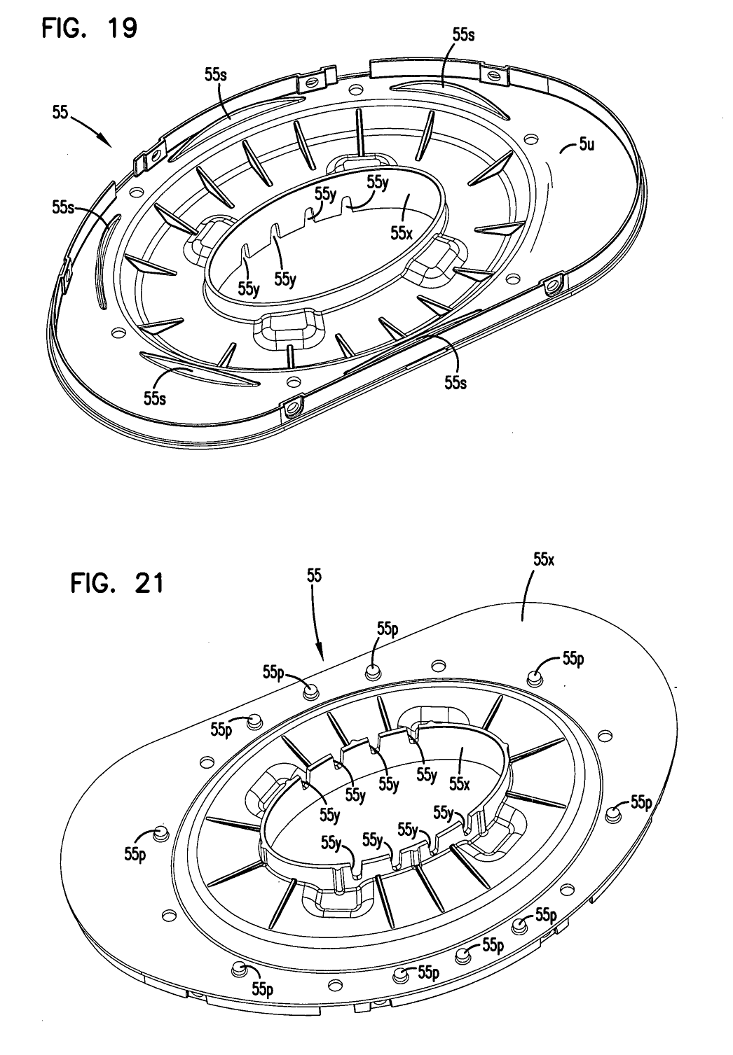

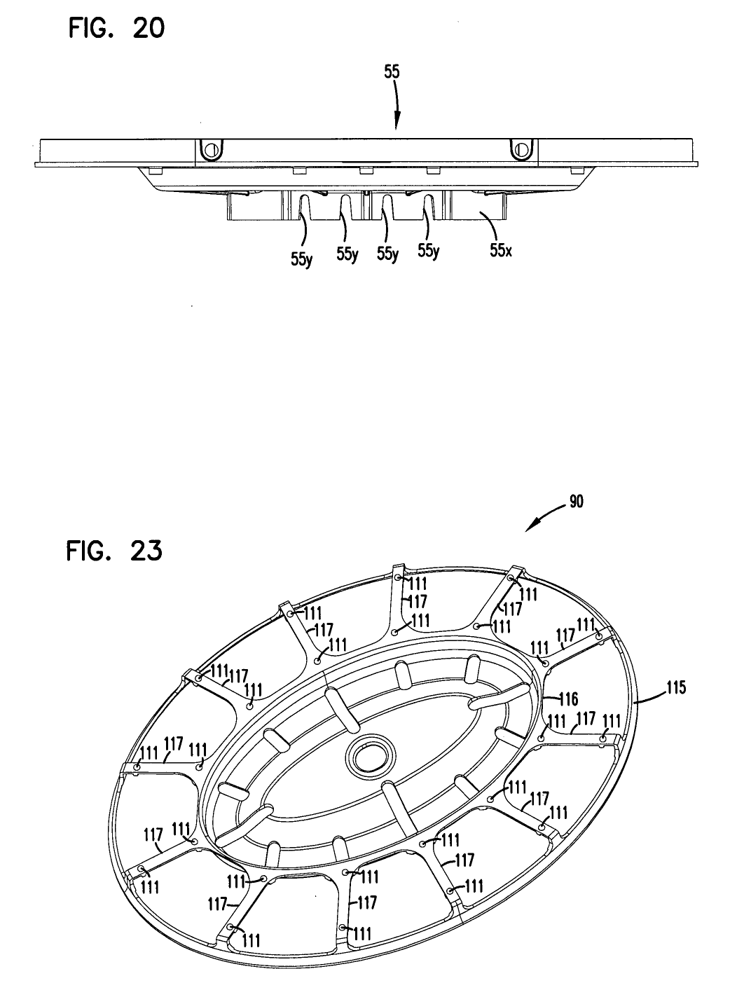

In FIG. 21, a bottom perspective view of seal plate assembly 55 is depicted. In FIG. 19 a top perspective view of seal plate 55 is viewable. In FIG. 20, a side elevational view of a seal plate 55 is viewable. Referring to FIGS. 19-21, it is noted that the seal plate 55 depicted in FIGS. 19-21, differs from seal plate 55, FIG. 14, by the presence of optional slots or grooves 55y in hub 55x. The slots or grooves 55y provide flexibility in hub 55x, when inlet stack 25 is snapped in place.

Referring to FIG. 19, on upper side 55u of seal plate assembly 55, are provided spaced axial projections 55s. These projections provide structural rigidity.

Referring to FIG. 21, on bottom surface 55t of seal plate assembly 55 are provided spaced projections 55p. These projections provide for a compression stop.

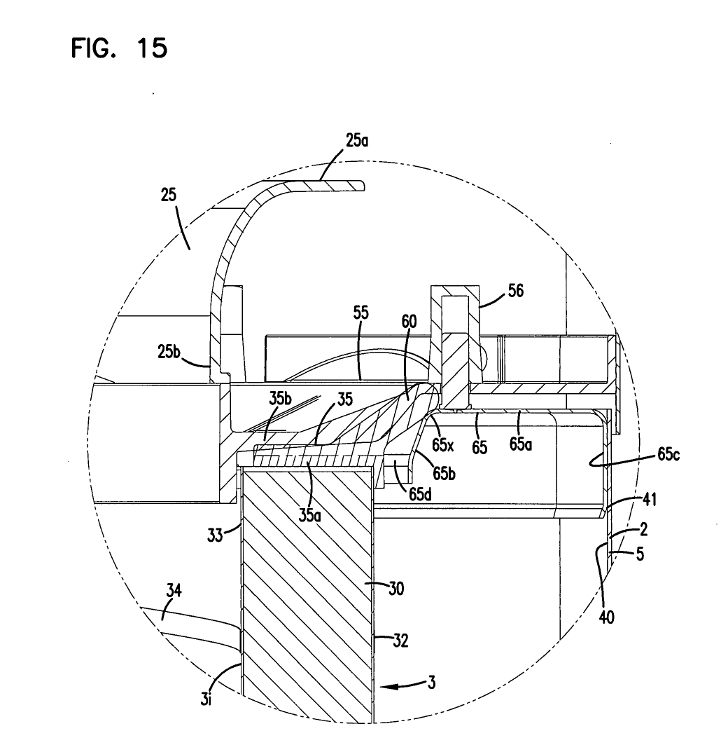

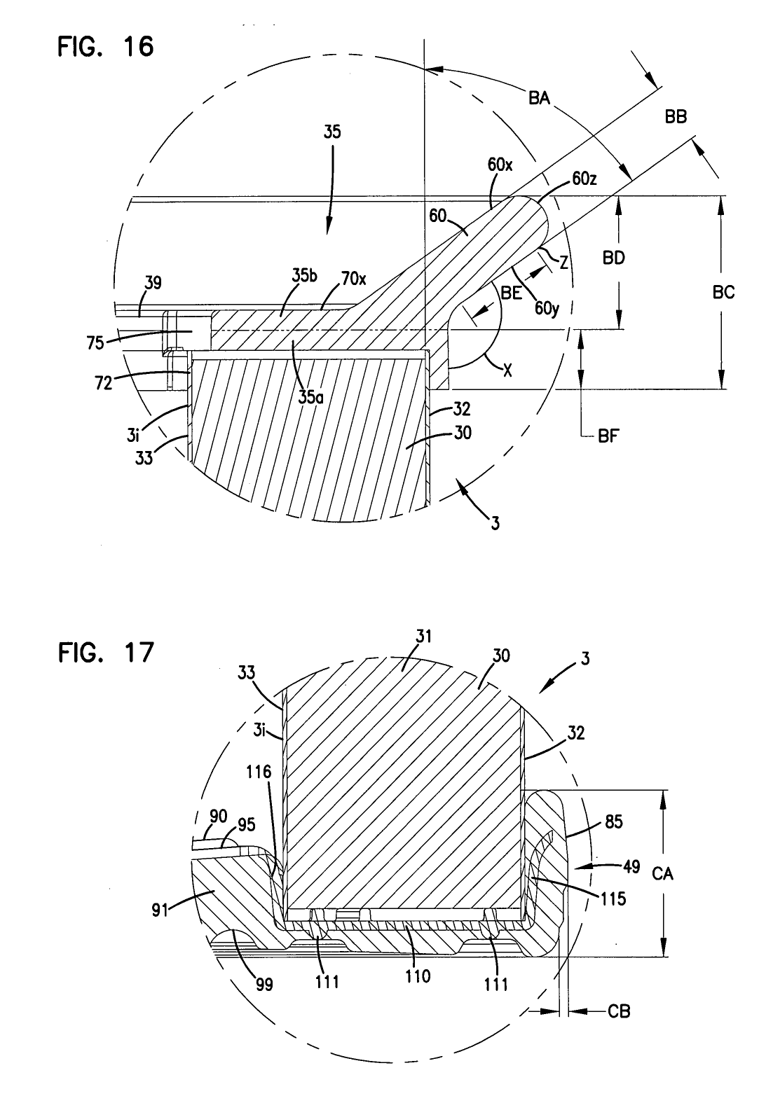

Attention is directed to FIG. 16, in which end cap 35 is depicted in cross-section. Seal member 60 is viewable. For the example shown, angle x is an obtuse (>90°, <180°) angle under a side lip 60 toward end cap 36 and between a direction of extension of lip 60, and a central axis (or side) of media pack 30. The angle x is typically at least 95°, usually not more than 170°, and often at least 110°, for example within the range of 110°-170°, inclusive; typically 115°-160°, inclusive. The typical example shown is within the range of 120°-140°, inclusive. Seal lip 60 has opposite, generally parallel sides 60x, 60y and a curved end 60z. The opposite sides 60x, 60y generally extend parallel or nearly parallel with one another, spaced apart by a distance appropriate for the sealing and the material use, typically the distance being within the range of about 5-20 mm, inclusive; typically 7-15 mm, inclusive.

The length of side 60y from vertex y to location z, where curved end 60z begins the curve, is usually at least 10 mm, typically 10 to 20 mm inclusive, for example 12-18 mm, inclusive. This corresponds to dimension BE, FIG. 16.

A variety of materials can be utilized for the molded end cap 35. Typically a molded-in-place end cap 35 comprising a compressible polyurethane foam in region 35b, will be a polyurethane foam having an as molded density of no greater than 30 lbs/cu. ft. (0.48 g/cc), sometimes no greater than 16 lbs/cu. ft. (0.25 g/cc) and in typical instances no less than 8 lbs/cu. ft (0.12 g/cc), although alternatives are possible. Example of useable materials are compressible polyurethane foams as described for example in U.S. Pat. No. 5,670,712, incorporated herein by reference. However, alternatives are possible.

Typically, the material in region 35b will have a hardness, Shore A, of no greater than about 25, typically no greater than about 22, usually within the range of 10 to 22, inclusive.

For the material in region 35a, typically a harder, stiffer, polyurethane, not readily compressible under hand pressures, would be used. Typically a material that forms a hard rigid end cap section that does not deform to human touch (hand pressure) is preferable. The density is not critical, as long as the material is sufficiently strong and rigid. For example a urethane of 25.4-29.4 pounds/cu. ft. can be used. The use of a urethane at both regions 35a, 35b, facilitates an end cap 35 that does not separate in use.

From the above, it will be understood that when cartridge 3 is installed within housing 2, FIG. 3, the seal plate assembly 55 will: (a) compress seal member 60, forming a seal between the cartridge 3 and the housing 2; (b) receive projections 77 on cartridge 3 in receivers 83; and (c) will mate, via ribs 81, 84 (FIG. 14) with insets 72.

This combination of engagement between the seal plate assembly 55 and end cap 35 provides several effects. One is a housing seal arrangement 50 between the cartridge 3 and the housing 2, as previously characterized. A second, is a seal between the seal plate 55 and the retainer/seal support 65, previously discussed. A third is inhibition to movement of the cartridge 3 relative to the housing 2, as a result of: (a) the mating fit between selected ribs 81, 84 on seal plate assembly 55 and insets 72 in the cartridge 3; and, (b) the mating fit between projections 77 and receivers 83.

The interactions characterized involving the ribs 81, 84 and receivers 83 with insets 72 and projections 77, facilitate stability of the housing seal arrangement 50. A reason is that end cap 35 cannot rock or twist relative to the housing 2, due to the interference fit with the seal plate assembly 55. This means that the flange 60 is less likely to be subjected to a twisting or tearing motion, when the cartridge 3 is installed in the housing 2 and the air cleaner 1 is used while the vehicle is operated and subjected to vibration and shock. Further, utilization of a compressible foam polyurethane for the end cap section 35b, will help dampen the effect of vibration or shock to which the air cleaner housing 4 is subjected, with respect to the filter cartridge 3.

Referring to FIG. 5, it is noted that the filter cartridge 3 is provided with a generally oval or elliptical shaped cross-sectional configuration, as well as an oval shaped seal lip 60. That is, the cartridge 3 has a long or primary cross-sectional axis indicated at 6-6; and, a relatively short or minor cross-sectional dimension as indicated at 7-7. It is noted that the principles described here can be applied with a variety of shapes of cartridges 3. However, the oval (elliptical) shape depicted in FIG. 5, is particularly convenient for utilization of the interior space 2i of a housing having the non-circular cross-section, FIG. 2, discussed above. In typical arrangements, a ratio of the shorter cross-sectional axis to the longer cross-sectional axis, for the seal flange 60, will typically be within the range of 0.4 to 0.9, inclusive; and, a ratio of a shorter cross-sectional axis to the longer cross-sectional axis for the media pack 30, will be in the range of 0.4 to 0.9, inclusive, although alternatives for each ratio are possible. Typically, each ratio is within the range of 0.5-0.8 inclusive.

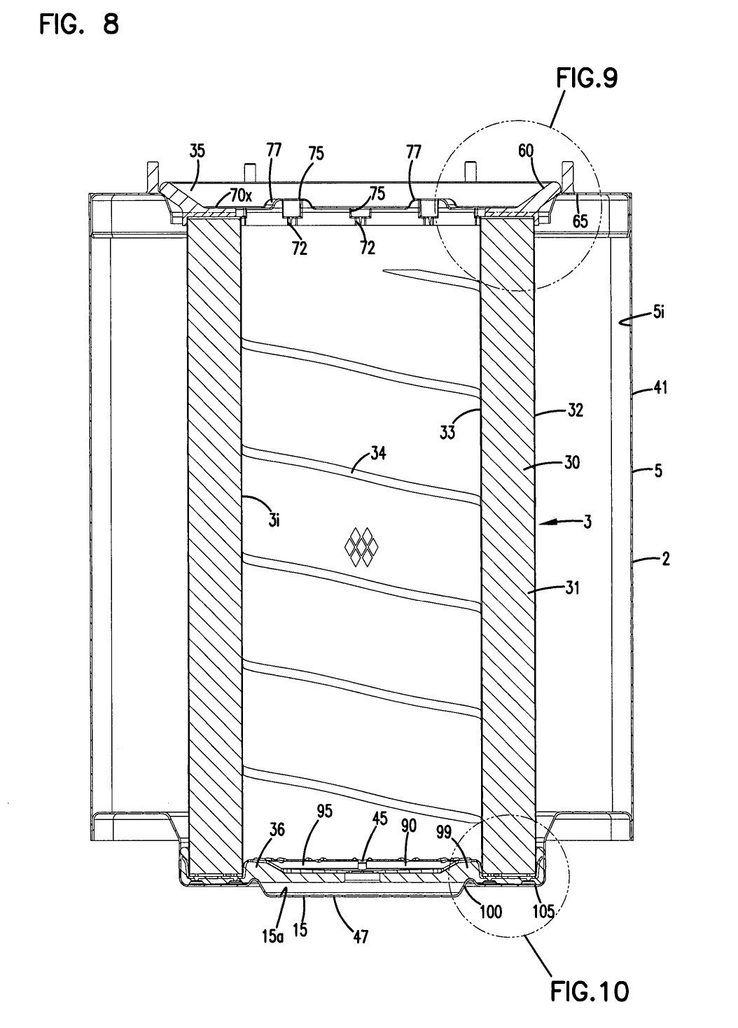

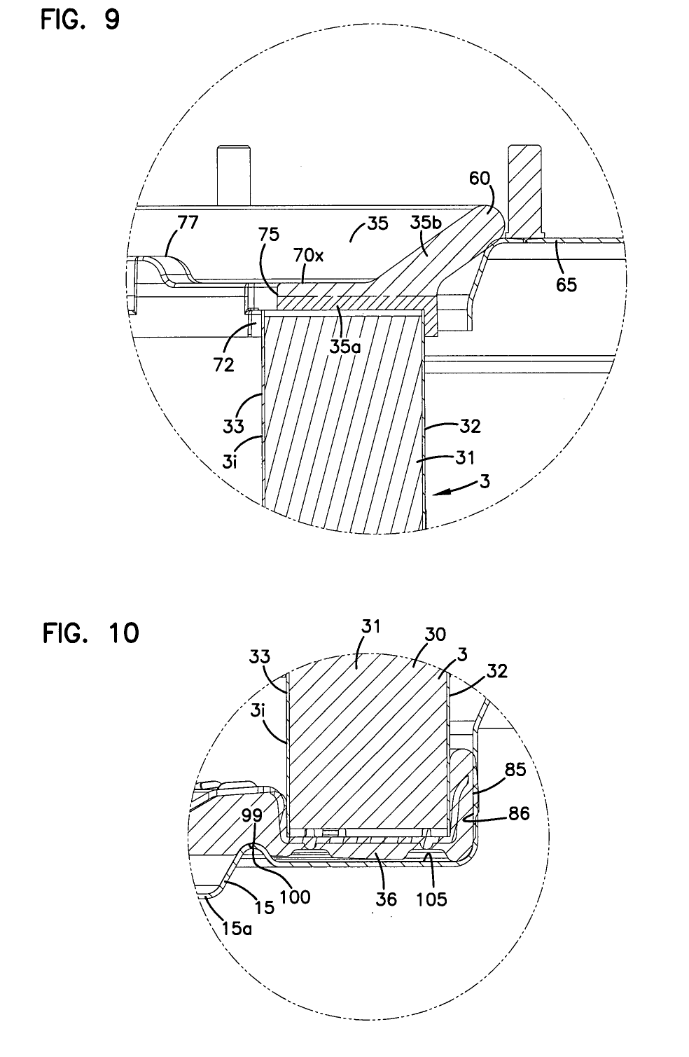

As discussed previously, a housing seal arrangement 49, FIG. 3, is also provided between the cartridge 3 and a lower portion of the housing base 5. With respect to this, attention is directed to FIGS. 8 and 10. FIG. 8 is a cross-sectional view analogous to FIG. 3, except showing the air cleaner 1 with the inlet/access cover assembly 6 and seal plate assembly 55 removed. FIG. 10 is an enlarged fragmentary view of a portion of FIG. 8. In connection with FIG. 8, and the enlarged fragmentary view of FIG. 9, end cap 35 is shown nesting against seal support member 65, before sealing engagement with the seal plate assembly 55, FIG. 3.

Referring to FIG. 10, cartridge 3 includes end cap 36. End cap 36 is provided with an outer annular portion 85, which operates to provide a seal with a portion of housing 2. In particular, outer annular portion 85 of end cap 36 comprises a seal material, for example, compressible polyurethane foam. When inserted within lower portion 15 of housing 2, an outwardly directed radial seal can be provided against annular housing seal surface 86. The material of outer annular portion 85 may comprise an analogous polyurethane foam, to that utilized for end cap section 35b.

Referring to FIG. 5, it is noted that end cap 36 generally has an oval (for example elliptical) outer perimeter shape for seal member 85, analogous to the perimeter shape for cartridge media pack 3, and end cap 35.

Attention is now directed to FIG. 18, a bottom perspective view of cartridge 3. Here the oval outer perimeter shape for seal region 85 of end cap 36 is easily inspected.

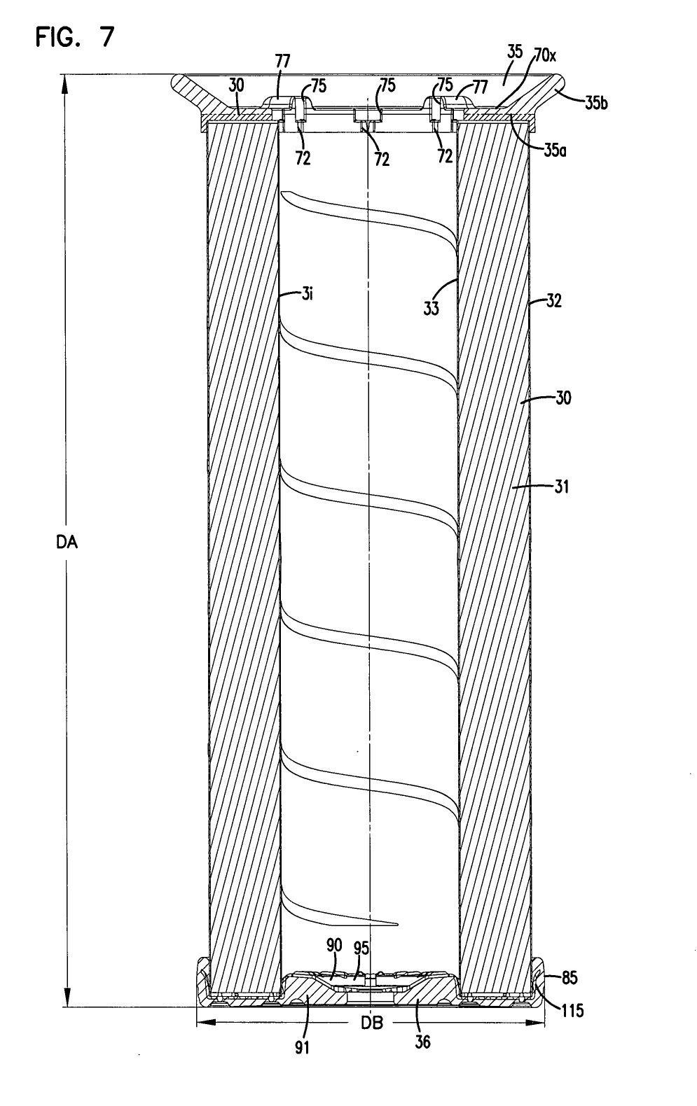

Attention is now directed to FIGS. 6 and 7, in which cartridge 3 is depicted in cross-section, FIG. 6 being a cross-section taken generally along line 6-6, FIG. 5; and, FIG. 7 being a cross-section taken generally along line 7-7, FIG. 5.

Referring to FIG. 6 first, attention is directed to end cap 36. For the example shown, end cap 36 comprises a composite end cap including insert 90 overmolded and secured in place by mold-in-place end cap material 91. The insert 90 would generally comprise a preform, molded from a hard plastic such as a high impact polystyrene, although alternatives are possible. During assembly the preform 90 would be attached to media pack 3, and the end of the media pack 3 with the insert 90 thereon would be inserted into a mold in which is included a resin formulation for molded-in-place overmold 91. Still referring to FIG. 6, insert 90 includes a central flow direction surface portion 95 configured to direct liquid thereon, in gravity flow toward drainage arrangement 45. The drainage arrangement 45 may comprise a single central aperture or a plurality of apertures. Typically the total open or perimeter area of drainage arrangement 45, in engagement with upper (inside) surface 36u of end cap 36 would be no greater than 5%, usually no more than 4% and typically 3% or less, of a total inside perimeter area defined by media pack 30. Herein the term “total inside perimeter area” when used in this context, is meant to refer to a cross-sectional area defined within region 3i by surrounding media pack 30. Alternately stated, it is a projected perimeter area defined in surface 36u by surrounding media pack 30.

Typically, the total inside perimeter (open) area of the drain arrangement 45, whether a single aperture or multiple apertures, is no more than 2.0 sq. inch (13 sq. cm.), typically no more than 1.5 sq. inch (92 sq. cm.), and usually 0.5 sq. inch (3.2 sq. cm.) or less.

In more general terms, the total open area of the drainage arrangement 45, is typically no more than 40% of a total inside perimeter area defined by the media pack 30; and, the total inside perimeter area of the drain arrangement 45 is typically no more than about 10 sq. inches (64.5 sq. cm.). It is noted that alternatives are possible, but a relatively small size for the total open area of the drainage arrangement characterized, is typical, to help retain contaminant inside cartridge 3. Usually, the drain arrangement has an area of at least 0.1 sq. inch (0.6 sq. cm.), and typically at least 0.5% of the interior surface area.

In general, the open area of drainage arrangement 45 is preferably smaller than an open area of aperture 39 in end cap 35.

Still referring to FIG. 6, molded-in-place material 91 is provided with central drain arrangement 91i, receiving flow from central drain arrangement 45. In addition, mold portion 91 includes trough 99. For the example shown trough 99 has a generally semi-circular cross-section, and defines an oval shape mirroring an inner perimeter of media pack 30, generally spaced inwardly therefrom.

Referring to FIG. 8, trough 99 is configured to receive (mate with) an upper projection 100, in housing bottom 15. This engagement can provide for assistance in inhibiting movement of material from central region 15a of housing bottom 15, toward outer perimeter region 105, FIGS. 8 and 10.

Referring to FIG. 17, it is noted that preform insert 90 includes an end portion 110, which axially overlaps media pack 30, and has spaced projections 111 thereon, projecting axially away from media pack 30 in axial overlap therewith. Projections 111 will form mold standoffs, during molding of overmold portion 91.

Still referring to FIG. 17, preform insert 90 further includes outer rim section 115, which surrounds the media pack 30 and helps retain the media pack 30 in an oval shape, between outer rim 115 and an inner rim 116 of the insert 90.

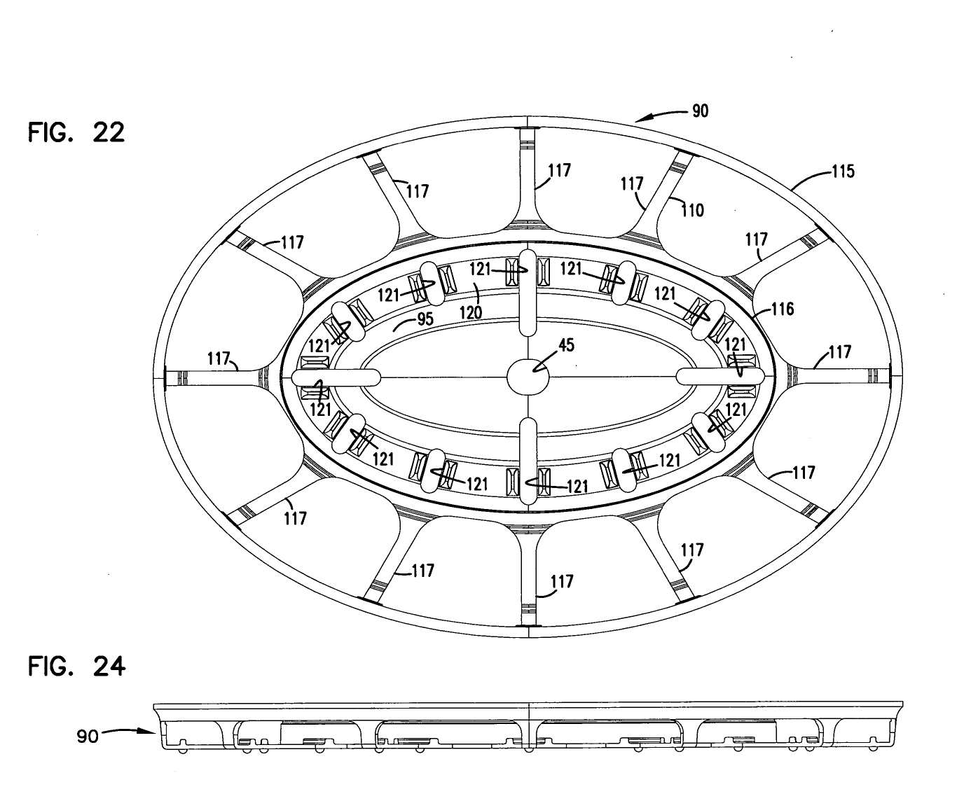

Attention is now directed to FIG. 22-24, in which preform insert 90 is depicted in various views. Referring first to FIG. 22, preform 90 is depicted in a top plan view, i.e., a view looking down on the insert 90 from above. The outer rim 115 can be seen as a continuous oval shaped rim. The inner rim 116 can also be seen. End portion 110 can be seen as comprising a plurality of ribs 117, spaced from one another in extension between inner rim 116 and outer rim 115. Spacing between ribs 117, allows for resin used to form mold-in-place end cap portion 91, FIG. 6, to rise and engage the media pack 30 when positioned between the rims 116, 115.

Still referring to FIG. 22, inner region 120 of preform 90, includes: free rise apertures 121, which provide for polymer rise during curing of mold-in-place portion 91; funnel surface 95 and drain aperture arrangement 45.

In FIG. 23, a bottom perspective view of preform 90 is provided. Here projections 111 associated with each one of the ribs 117 are viewable.

In FIG. 24, a side elevational view of preform 90 is provided for clarity.

In the figures, some example dimensions are provided. The example dimensions are as follows: In FIG. 6, AA=500.5 mm; AB=266.2 mm; in FIG. 7, DA=500.5 mm; DB=189.8 mm; in FIG. 16, BA=55°; BB=9.5 mm; BC=31 mm; BD=21.5 mm; BE-15 mm; BF=9.5 mm; in FIG. 17, CA=26.9 mm; CB=1.5 mm. Other dimensions can be taken from scale.

Although alternatives are possible, the features characterized herein were developed specifically for use with a metal housing, especially metal housings with a polished, glossy, decorative stainless steel outer surface. With such configurations, features permanently secured to one another can be attached, for example, through welding.

It is noted that the principles of the present disclosure can be provided in a variety of arrangements, including ones with alternate dimensions and configurations. Further, many features have been described and illustrated with specificity. There is no requirement that an arrangement include all of the features characterized herein, to provide for some advantage according to the present disclosure.

1.-24. (canceled)

1. An air filter cartridge comprising:
(a) a media pack extending between first and second end caps,
(i) the first end cap including a central air flow aperture and an outwardly directed pinch seal flange extending radially away from the media pack; and,
(ii) the second end cap including: a housing having a molded-in-place radial seal portion thereon; and, a drain arrangement therethrough.

2. An air filter cartridge according to claim 1 wherein:
(a) the pinch seal flange extends in a direction away from the second end cap.

3. An air filter cartridge according to claim 2 wherein:
(a) the housing seal portion of the second end cap includes an outwardly directed radial seal portion.

4. An air filter cartridge according to claim 1 wherein:
(a) the first end cap includes at least one inset extending therethrough; the at least one inset being adjacent, and in communication with, the central air flow aperture.

5. An air filter cartridge according to claim 1 wherein:
(a) the first end cap includes a plurality of radially spaced insets extending therethrough, each inset being adjacent, and in communication with, the central air flow aperture.

6. An air filter cartridge according claim 1 wherein:
(a) the first end cap includes an axial end portion in axial overlap with the media pack;
(i) the outwardly directed pinch seal flange extending outwardly from the axial end portion in a direction away from the central air flow aperture; and,
(ii) the axial end portion including a plurality of axial projections thereon: projecting away from the media pack; in axial overlap with the media pack; and, adjacent the central air flow aperture.

7. An air filter cartridge according to claim 6 wherein:
(a) the cartridge is also in accord with claim 5; and,
(b) each one of the axial projections includes an inset extending therethrough.

8. An air filter cartridge according claim 11 wherein:
(a) the pinch seal flange has opposite side walls spaced at least 5 mm and not more than 20 mm apart.

9. An air filter cartridge according claim 1 wherein:
(a) the pinch seal flange extends away from the media pack at an obtuse angle x thereto;
(i) the obtuse angle x being at least 110° and not more than 170°.

10. An air filter cartridge according to claim 9 wherein:
(a) the obtuse angle x is within the range of 115°-160°, inclusive.

11. An air filter cartridge according claim 1 wherein:
(a) the pinch seal flange defines an oval outer perimeter shape.

12. An air filter cartridge according claim 1 wherein:
(a) the pinch seal flange on first end cap comprises a molded-in-place polyurethane foam.

13. An air filter cartridge according to claim 1 wherein:
(a) the second end cap includes an oval outer perimeter shape.

14. An air filter cartridge according to claim 13 wherein:
(a) the second end cap includes an outer axial surface with an oval shaped trough therein.

15. An air filter cartridge according claim 14 wherein:
(a) the oval shaped trough is positioned in axial overlap with an interior region surrounded by the media pack.

16. An air filter cartridge according to claim 15 wherein:
(a) the second end cap comprises a preform secured in place with molded-in-place end cap material.

17. An air filter cartridge according to claim 16 wherein:
(a) the preform includes an outer rim and an inner rim;
(i) the media pack being positioned with an end portion between the outer and inner rims; and,
(b) the preform includes a plurality of spaced ribs extending between the outer and inner rims.

18. An air filter cartridge according to claim 1 wherein:
(a) the media pack has an oval perimeter shape.

19. An air filter cartridge according to any claim 1 wherein:
(a) the media pack includes inner and outer media support liners.

20. An air filter cartridge according to claim 1 wherein:
(a) the first end cap includes an axially inner portion and an axially outer portion;
(i) the inner portion comprising a molded-in-place polyurethane;
(ii) the outer portion comprising a molded-in-place polyurethane and including the pinch seal flange;
(A) the axially inner portion being harder than the axially outer portion.
